(19) United States
(12) Patent Application Publication
(10) Pub. No.: US 2018/0236314 A1
(43) Pub. Date: Aug. 23, 2018

(54) SOMATOSENSORY DEVICE

(71) Applicant: SHENZHEN COOLLANG CLOUD COMPUTING CO., LTD., SHENZHEN (CN)

(72) Inventors: ZHICONG SONG, SHENZHEN (GD); JUNHUA HUANG, SHENZHEN (CN)

(21) Appl. No.: 15/754,685

(22) PCT Filed: Mar. 14, 2016
(86) PCT No.: PCT/CN2016/076301

§ 371 Date: Feb. 23, 2018

(30) Foreign Application Priority Data
Aug. 26, 2015 (CN) 201510530837.1

(51) Int. Cl. A63B 49/08; G01P 13/00

(52) U.S. Cl. CPC A63B 49/08; A63B 60/06; G01P 13/00

(57) ABSTRACT

A somatosensor device comprises a handle (10) having a hollow free end (130) to form a cavity (133) with an opening in a tail end surface (131); a wireless charging circuit board (30) overlapped on the tail end surface (131); a tracker (50) fixed on the wireless charging circuit board (30) and electrically connected with same, the tracker (50) inserted into the cavity (133) as the wireless charging circuit board (30) is overlapped on the tail end surface (131); and an end cap (70) covered on the free end (130) of the handle(10), so as to seal the cavity (133) with the opening in the tail end surface (131). The configuration takes account of the sealability and wireless charging.

### CROSS REFERENCE

This application is continuation of, and claims the benefit of priority from the International Application PCT/CN2016/076301, filed Mar. 14, 2016, which claims the benefit of priority from Chinese Patent Application No. CN201510530837.1, filed on Aug. 26, 2015, the entire contents of all of which are incorporated herein by reference.

### TECHNICAL FIELD

The disclosure relates to a field of interactive devices, and more specifically to a somatosensory device.

### BACKGROUND

With the rapid development of various interactive applications, somatosensory devices for enabling various functions in interactive applications vary with interactive scenes. However, any kind of somatosensory device is used for tracking momvents of the somatosensory device to obtain various tracking data presenting movement procedure of the somatosensory device.

Specifically, the somatosensory device is carried by the user. In order to track and identify its movement, the somatosensory device is internally equipped with a variety of tracking devices and batteries supplying power for the tracking devices, and the housing of the somatosensory device is specially equipped with a charging socket for charging power-depleted batteries.

However, the charging socket in the somatosensory device will destroy the internal leak tightness of the somatosensory device, which further brings many problems for the somatosensory device.

### SUMMARY

The disclosure aims to overcome at least one of the shortcomings of the existing technology, and provides a somatosensory device, which not only can ensure the internal leak tightness,but also is chargeable.

In a aspect, the disclosure provides a somatosensory device, comprising:

a handle, having a hollow free end to form a cavity with an opening in a tail end surface;

a wireless charging circuit board, overlapped on the tail end surface;

a tracker, fixed on the wireless charging circuit board and electrically connected to the wireless charging circuit board, the tracker being inserted into the cavity as the wireless charging circuit board is overlapped on the tail end surface; and

an end cap, covered on the free end of the handle, so as to seal the cavity with the opening in the tail end surface.

In an embodiment, the tracker and the wireless charging circuit board form a T-shaped fixed structure or a layered fixed structure.

In an embodiment, the cross section of the tracker inserted into the cavity along the radial direction is matched with the cross section of the cavity.

In an embodiment, the fixed structure formed by the tracker and the wireless charging circuit board is T-shaped, and the tracker is in the shape of a strip and has a length matched with the depth of the cavity.

In an embodiment, the tracker comprises a main chip and a battery, and the battery respectively electrically connects the main chip and the wireless charging circuit board.

In an embodiment, the main chip is in the shape of a strip, and the main chip is vertically fixed on the wireless charging circuit board to form a T-shaped fixed structure with the wireless charging circuit board, and the battery is fixed on the back surface of the main chip.

In an embodiment, the somatosensory device further comprises a charging base matched with the handle; the charging base comprises a base body, a coil and a charging controller; an upper part of the base body is opened and recessed inwardly to form a chamber for providing a placement space for charging the tracker in the handle; and the coil is tightly attached to the bottom of the chamber, and the charging controller is disposed in the base body and electrically connected to the coil.

In an embodiment, the base body is a double-layer structure comprising an upper cover forming the chamber, the upper cover being an inner layer of the base body, and the coil is disposed in the double-layer structure of the base body and clings to the bottom of the upper cover; the charging base further includes an elastic fixing member disposed on a side wall of the upper cover to fix the somatosensory device inserted into the chamber.

In an embodiment, the handle is a badminton racket handle in the somatosensory device as described above.

In an embodiment, the tail end surface and the wireless charging circuit board are both hexagonal, and the wireless charging circuit board clings to the end cap covered on the free end.

According to the above technical solutions, the disclosure at least provides the advantageous effects as follows: the somatosensory device comprises a handle, a wireless charging circuit board, a tracker and an end cap. The free end of the handle forms a cavity with an opening in a tail end surface. The wireless charging circuit board and the tracker are the internal components of the somatosensory device, and the tracker is fixed on the wireless charging circuit board and electrically connected to the wireless charging circuit board. Therefore, as the wireless charging circuit is overlapped in the opening of the tail end surface, the tracker is inserted into the cavity and the cavity is sealed by the end cap covered on the free end to ensure the internal leak tightness. And because of the wireless charging circuit board, there is no need to additionally dispose a charging socket, which ensures leak tightness of the internal devices, and chargablity of the somatosensory device.

### BRIEF DESCRIPTION OF THE DRAWINGS

In order to clearly describe technic solutions in the embodiments of the disclosure, the drawings combined by embodiments have been described simply hereinafter. Obviously, the drawings in the description are merely some embodiments of this disclosure. Other drawings can be made according to these drawings by an ordinary person skilled in the art without the creative work

FIG. 1 is a structural schematic view of a somatosensory device according to an embodiment of the disclosure.

FIG. 2 is a structural schematic view of a charging base according to an embodiment of the disclosure.

Description of reference numerals: 10 handle; 110 fixed end; 130 Free end;131 tail end surface;133 cavity; 30 wireless charging circuit board; 50 tracker; 510 main chip; 530 battery; 70 end cap; 90 charging base; 910 base body; 911 chamber; 912 socket; 913 upper cover; 9131 side wall; 9133 receiving groove; 916 base; 9161 footpad; 917 outer cylinder; 9171 light guide column; 9173 LED lamp; 918 coil holder; 919 stopper column; 930 coil 950 charging controller; 951 control board; 970 elastic fixing member; 980 counter weight.

### DETAILED DESCRIPTION

Hereinafter, the disclosure will be further explained in detail with reference to the accompanying drawings and embodiments for making the object, the technical solutions and the advantages of the present invention clearer. It should be understood that the specific embodiments described herein are merely used to explain the disclosure, and are not intended to limit the present invention.

It should be noted that when an element is referred to as being “fixed on” or “disposed on” another element, the element can be directly on another element or there may be at least a middle element between the element and another element. When an element is referred to as being “connected” to another element, the element can be directly connected to the other element or there may be a middle element between the element and another element.

It should also be noted that, terms such as left, right, upper and lower in the embodiments of the disclosure are merely relative concepts or are referenced to the normal usage state of the product and should not be considered as restrictive.

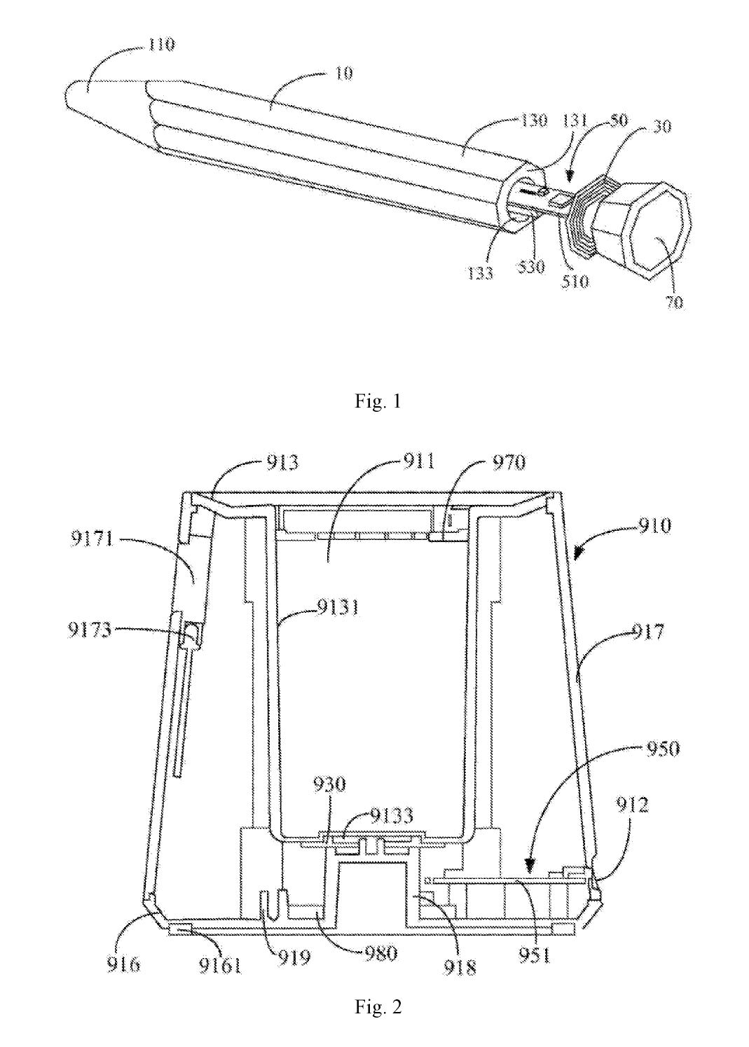

As shown in FIG. 1, in an embodiment, a somatosensory device includes a handle 10, a wireless charging circuit board 30, a tracker 50 and an end cap 70. The handle 10 is used to realize the holding of the somatosensory device, one end of which is a fixed end 110 and the other end of which is a free end 130. The free end 130 is hollow and forms a cavity 133 with an opening in tail end surface 131. The shape of the handle 10 is designed according to the type and holding requirement of the somatosensory device.

The tracker 50 is fixed on the wireless charging circuit board 30 and electrically connected to the wireless charging circuit board 30. The tracker 50 is used to track the movement process of the somatosensory device in order to obtain various tracking data. When the battery is exhausted, the tracker 50 is charged through the wireless charging circuit board 30 to obtain the power needed to maintain the normal operation.

The wireless charging circuit board 30 and the tracker 50 that are fixed integrally, as the internal components of the somatosensory device, are assembled in the handle 10 through the cavity 133 so as to accurately track the movement of the somatosensory device held by the user.

Specifically, the wireless charging circuit board 30 is overlapped on the tail end surface 131, through which the tracker 50 is inserted into the cavity 133, so as to fit the wireless charging circuit board 30 and the tracker 50 into the handle 10.

The end cap 70 covers the free end 130 of the handle 10 to seal the cavity 133 with an opening in the tail end surface 131. In this case, by the cooperation of the tail end surface 131 and the end cap 70, the wireless charging circuit board 30 is fixed in the handle 10, thereby the tracker 50 is fixed in the cavity 133.

The wireless charging circuit board 30 is disposed in the somatosensory device, so that the somatosensory device does not need a charging socket, which ensures the leak tightness of the whole somatosensory device and prevents the somatosensory device from moisture and water infiltration, so that the internal components of the somatosensory device will not suffer fatal damage caused by the impact of the external environment, and the overall lifetime of somatosensory devices will be greatly improved.

In the somatosensory device as described above, the user takes exercise with griping the handle 10, and the tracker 50 inserted in the cavity 133 is precisely implanted in the portion of the handle 10 where the user is holding, thereby ensuring the precision of monitoring and identifying the movement of the somatosensory device.

In an embodiment, tracker 50 and wireless charging circuit board 30 form a T-shaped fixed structure or a layered fixed structure.

In other words, the tracker 50 and the wireless charging circuit board 30 may be disposed perpendicular to each other or parallel. If disposed perpendicularly, the tracker 50 is erected on the wireless charging circuit board 30, and if disposed in parallel, the tracker 50 is tightly attached to the wireless charging circuit board 30 in parallel to form a layered fixed structure.

No matter what kind of fixed structure is adopted, the tracker 50 is always matched with the opening 133 in tail end surface 131 of the handle 10 and the cavity 133, that is, the wireless charging circuit board 30 is always placed in the opening of the tail end surface 131, and the tracker 50 is always inserted in the cavity 133 to realize the assembly of the wireless charging circuit board 30 and the tracker 50 in the handle 10.

The wireless charging circuit board 30 is parallel to the bottom plane of the end cap 70, which greatly helps to realize the wireless charging and improves the efficiency of wireless charging.

Further, the cross section of the tracker 50 inserted into the cavity 133 along the radial direction is matched with the cross section of the cavity 133.

The shape of the tracker 50 corresponds to the cavity 133 so as to avoid lateral sloshing of the tracker 50 and ensure the stability of assembly.

Further, the fixed structure formed by the tracker 50 and the wireless charging circuit board 30 is T-shaped, and the tracker 50 is in the shape of strip and has a length matched with the depth of the cavity 133.

Although overlapping of the wireless charging circuit board 30 on the tail end surface 131 of the handle 10 and fixing of the wireless charging circuit board 30 to the tail end surface 131 of the handle 10 with the cooperation of the end cap 70 perform fixing of the tracker 50 in the cavity 133, the tracker 50 matched with the depth of the cavity 133 further ensures the stability of the wireless charging circuit board 30 and the tracker 50 in the somatosensory device, thereby greatly improving the stability and reliability of the somatosensory device.

Further, the tracker 50 includes a main chip 510 and a battery 530 electrically connected to the main chip 510 and the wireless charging circuit board 30 respectively. The main chip 510 tracks the movement of the somatosensory device held by user, and the battery 530 supplies power for the main chip 510, and is charged through the wireless charging circuit board 30 when in the low power. The battery 530 is placed on the back surface of the main chip 510.

Further, the main chip 510 is tabular and in the shape of a strip. The main chip 510 is vertically fixed on the wireless charging circuit board 30 to form a T-shaped fixed structure with the wireless charging circuit board 30. The battery 530 is fixed on the back surface of the main chip 510, so that the battery 530 is also vertically fixed on the wireless charging circuit board 30.

As described above, in the tracker 50, the main chip 510 is tabular and matched with the cross section of the cavity 133, and is parallelly attached to the wireless charging circuit board 30. The battery 530 is fixed on the main chip 510, and extends axially in the cavity 133 to achieve a stable arrangement of the tracker 50 in the lateral direction.

The somatosensory device described above may be a smart badminton racket, a golf club, a pingpong bat, a somatosensory game handle and the like, which are not described herein in detail.

The smart badminton racket is taken as an example to elaborate below. In this embodiment, the handle 10 is a badminton racket handle, which is in the form of a rod. Correspondingly, the tail end surface 131 of the handle 10 is hexagonal. An opening is formed in the hexagonal tail end surface 131, which extends axially from the opening to form a hollow cavity 133.

The wireless charging circuit board 30, which is overlapped in the opening of the tail end surface 131, is also hexagonal, and has a size similar to the tail end surface 131, so as to achieve a stable overlap.

The cross section of the end cap 70 is matched with the tail end surface 131 to ensure the end cap 70 steadily covering at the end of the handle 10, and the end cap 70 is tightly attached to the wireless charging circuit board 30.

The smart badminton racket as described above makes the traditional badminton racket intelligentized while ensuring that original performance parameters of the traditional badminton will not change and the structure as described above will provide the best sealing performance.

In addition, since the tracker 50 is implanted in the free end 130 of the smart badminton racket, it is unnecessary to place a racket counter weight in the smart badminton racket. In the tracker 50, since the free end 130 of the handle 10 is inserted into the cavity 133, and due to space structure and excellent appearance of the main chip 510 in the shape of a strip, the defect is overcome that the main quality of the smart badminton racket is concentrated on the end cap 70, so as to realize intelligentizing the tennis badminton racket, while the badminton racket maintains the original sports function, for example, the original mass distribution and balance point.

At the same time, through the above-mentioned arrangement, the smart badminton racket will also be able to have a variety of professional performance parameters of the traditional badminton, as to get an intelligent badminton racket with a variety of sports functions.

For example, compared with the traditional badminton racket with the same sports function, as for the smart badminton racket, the overall quality of the main chip 510 and the battery 530 in the tracker 50 is controlled within a certain range of several grams, and other structure such as the handle 10 and the bezel can be tuned somewhat according to requirement, so as to ensure the overall quality unchanged, and maintain corresponding balance point and quality the same as those of the traditional badminton rackets with the corresponding function, so that important parameters by which the professionality of the the racket is measured, such as swing weight, will not be affected.

In addition, for the implementation of the smart badminton racket, the counter weight can be removed from the traditional badminton racket and the tracker 50 is directly implanted and the wireless charging circuit board 30 is assembled in the cavity for receiving the counter weight, so as to obtain the smart badminton racket. Therefore the smart badminton racket can be compatible with the traditional badminton racket, and is improved on the basis of the traditional badminton racket, which greatly reduces the cost and the difficulty of realizing the smart badminton racket.

In another embodiment, besides the handle 10, the wireless charging circuit board 30, the tracker 50 and the end cap 70 as described above, the somatosensory device further includes a charging base 90, as shown in FIG. 2.

The charging base 90 includes a base body 910, a coil 930 and a charging controller 950, wherein:

The base body 910 serves as the main body of the charging base 90 for charging the battery 530 in the tracker 50, that is, for placing the handle 10 of the somatosensory device and various internal devices of the charging base 90. In order to place the handle 10 in the charging base 90, an upper part of the base body 910 is opened and recessed inwardly to form a chamber 911 for providing a placement space for charging somatosensory device.

Because the charging base 90 is matched with the handle 10, the chamber 91 of the the base body 90 in the charging base 90 is matched with the portion of the handle 10 where the wireless charging circuit board 30 is disposed. For example, the wireless charging circuit board 30 can be disposed at the end of the handle 10. If the handle 10 is rod-shaped, the space provided by the chamber 911 is a columnar space, and has a radial width corresponding to outer diameter of the handle 10, and then the somatosensory device is firmly fixed in the chamber 911.

The coil 930 is used to electromagnetically sense the wireless charging circuit board 30 in the somatosensory device to wireless charge the somatosensory device. In the charging base 90, the coil 930 is closely attached to the bottom of the chamber 911, so that the coil 930 is disposed opposite to the wireless charging circuit board 30 in somatosensory device in the charged state.

The charging controller 950 is disposed in the base body 910 and electrically connected to the coil 930. The charging controller 950 controls the input of electric energy of the charging base 90.

By applying the charging base 90 as described above to the charging of the somatosensory device, the wireless charging of the somatosensory device is realized.The socket is no longer needed in the somatosensory device and the somatosensory device has excellent sealing performance, so that the internal components in the somatosensory device do not become damp, and the service life of the somatosensory device is greatly improved under the cooperation of the charging base 90.

In an embodiment, the base body 910 is a double-layered structure, that is, constituted of at least an inner layer and an outer layer. The base body 910 includes an upper cover 913 forming a cavity 911. The upper cover 913 is an inner layer of the base body 910. The coil 930 is disposed in the double-layer structure of the base base body 910 and clings to the bottom of the upper cover 913.

As for the somatosensory device, the wireless charging circuit board 30 for wireless charging in the somatosensory device is disposed at the end of the handle 10, and the end cap 70 covering the handle 10 and the bottom of the upper cover 913 are between the wireless charging circuit board 30 and the coil 930 in the charging base 90. Therefore, in a preferred embodiment, in order to ensure the effect of wireless charging, the bottom of the upper cover 913 is as thin as possible, so as to achieve the purpose of improving the charging efficiency.

Further, the charging base 90 as described above further includes an elastic fixing member 970, which is used to achieve a firm placement of the somatosensory device in the chamber 911. The elastic fixing member 970 is disposed on the side wall 9131 of the upper cover 913 to fix the somatosensory device which is inserted into the cavity 911. In a preferred embodiment, the elastic fixing member 970 is made of flexible glue.

Specifically, the elastic fixing member 970 is an elastic fixing ring, and the elastic fixing ring is disposed on the top of the side wall 9131.

Through the arrangement of the elastic fixing member 970, the somatosensory device keeps vertical during the charging without tilting.

In another embodiment, the base body 910 further includes a base 916 and an outer cylinder 917 fixed to the base 916. The base 916 and the outer cylinder 917 form the outer layer of the two-layer structure of the base body 910.

The outer layer of the base body 910 formed by the base 916 and the outer cylinder 917 is used to fix various devices and support the somatosensory device for charging.

Further, the base 916 protrudes upwardly to form a coil holder 918. The bottom of the upper cover 913 correspondingly protrudes upwardly to form a receiving groove 9133 corresponding to the coil holder 918. The coil 930 clings to the bottom of the upper cover 913 through the coil holder 918 and the receiving groove 9133 to fix the coil 930.

Further, the charging base 90 above applied to the somatosensory device further includes a counter weight 980 for ensuring the balance of the charging base 90, in particular, when the somatosensory device is placed in the chamber 911.

The coil holder 918 is located at the center of the base 916. The base 916 is provided with stopper columns 919 uniformly distributed around the coil holder 918 as a center. The counter weight 980 is disposed between the stopper columns 919 and the coil holder 918 to limit and fix the counter weight 980 through the stopper columns 919.

In an embodiment, the outer wall of the base body 910 is provided with a socket 912 electrically connected to the charging controller 950 for connection with a power outlet.

Further, the charging controller 950 includes a control board 951 and a storage battery (not shown) electrically connected to the control board 951. The storage battery is electrically connected to the socket 912.

Through the arrangement of the storage battery, the user only needs to carry the charging base 90 as described above to charge the somatosensory device at any time. For example, the user may insert the somatosensory device into the charging base 90 for charging when the somatosensory device is not in use, so as to keep the somatosensory device in the best status at anytime, anywhere.

Further, a plurality of footpads 9161 are also disposed on the bottom of the base 916, so that the charging base 90 can be placed more steadily.

Further, the outer cylinder 917 is further equipped with a light guide column 9171 and a LED lamp 9173 electrically connected to the control board 951 to serve as indicator lights.

In another embodiment, the effect of the counter weight 980 may be achieved by properly arranging the battery in the base 916, so the counter weight 980 are not needed to be placed in the base 916, as to simplify the structure of the charging base 90.

The above is merely some preferable embodiments, and not intended for limiting this invention. Any modifications, substitutions and improvements made without departing from the spirit and principle of this invention should be embraced by the protection scope of this invention.

What is claimed is:

1. A somatosensory device, comprising:
a handle, having a hollow free end to form a cavity with an opening in a tail end surface;
a wireless charging circuit board, overlapped on the tail end surface;
a tracker, fixed on the wireless charging circuit board and electrically connected to the wireless charging circuit board, the tracker being inserted into the cavity as the wireless charging circuit board is overlapped on the tail end surface; and
an end cap, covered on the free end of the handle, so as to seal the cavity with the opening in the tail end surface.

2. The somatosensory device according to claim 1, wherein the tracker and the wireless charging circuit board form a T-shaped fixed structure or a layered fixed structure.

3. The somatosensory device according to claim 2, wherein the cross section of the tracker inserted into the cavity along the radial direction is matched with the cross section of the cavity.

4. The somatosensory device according to claim 2, wherein the fixed structure formed by the tracker and the wireless charging circuit board is T-shaped, and the tracker is in the shape of a strip and has a length matched with the depth of the cavity.

5. The somatosensory device according to claim 2, wherein the tracker comprises a main chip and a battery, and the battery respectively electrically connects the main chip and the wireless charging circuit board.

6. The somatosensory device according to claim 5, wherein the main chip is in the shape of a strip, and the main chip is vertically fixed on the wireless charging circuit board to form the T-shaped fixed structure with the wireless charging circuit board, and the battery is fixed on the back surface of the main chip.

7. The somatosensory device according to claim 1, wherein the somatosensory device further comprises a charging base matched with the handle;
wherein the charging base comprises a base body, a coil and a charging controller;
an upper part of the base body is opened and recessed inwardly to form a chamber for providing a placement space for charging the tracker in the handle; and the coil is tightly attached to the bottom of the chamber, and the charging controller is disposed in the base body and electrically connected to the coil.

8. The somatosensory device according to claim 7, wherein the base body is a double-layer structure comprising an upper cover forming the chamber, wherein the upper cover is an inner layer of the base body, and the coil is disposed in the double-layer structure of the base body and clings to the bottom of the upper cover;
the charging base further comprises an elastic fixing member disposed on a side wall of the upper cover to fix the somatosensory device inserted into the chamber.

9. The somatosensory device according to any one of claims 1 to 8, wherein the handle is a badminton racket handle.

10. The somatosensory device according to claim 9, wherein the tail end surface and the wireless charging circuit board are both hexagonal, and the wireless charging circuit board clings to the end cap covered on the free end.

11. The somatosensory device according to claim 7, wherein the charging controller comprises a control board and a storage battery electrically connected to the control board.

12. The somatosensory device according to claim 8, wherein the base body further comprises a base and an outer cylinder fixed to the base, wherein the base and the outer cylinder form the outer layer of the two-layer structure of the base body;
the base protrudes upwardly to form a coil holder, the bottom of the upper cover correspondingly protrudes upwardly to form a receiving groove corresponding to the coil holder, and the coil clings to the bottom of the upper cover through the coil holder and the receiving groove.

13. The somatosensory device according to claim 12, wherein the charging base further comprises a counter weight, wherein the coil holder is located at the center of the base, and the base is provided with stopper columns uniformly distributed around the coil holder as a center, wherein the counter weight is disposed between the stopper column and the coil holder.
